(19) United States
(12) Patent Application Publication
(10) Pub. No.: US 2017/0232793 A1
(43) Pub. Date: Aug. 17, 2017

(54) WHEEL LIFT

(71) Applicant: INVENTIONWORX INC., Edmonton (CA)

(72) Inventor: Woon Tiong Ang, Edmonton (CA)

(21) Appl. No.: 15/523,334

(22) PCT Filed: Jun. 7, 2016
(86) PCT No.: PCT/CA2016/050648

§ 371 Date: Apr. 28, 2017

(30) Foreign Application Priority Data
Jun. 12, 2015 (CA) 2894165

(51) Int. Cl. B60B 29/00; B60B 30/02; B60B 30/10; B66F 5/04

(52) U.S. Cl. CPC B60B 29/001; B66F 5/04; B60B 29/002; B60B 30/02; B60B 30/10; B60B 2900/541; B60B 2340/12; B60B 2340/36; B60B 2340/70

(57) ABSTRACT

A wheel lift comprises a frame having ground engaging elements, a four bar linkage structure supported by the frame, lifting arms extending from the four bar linkage and for receiving and supporting a wheel and a handle for operating the four bar linkage to raise and lower the wheel. The frame defines an open space for receiving a wheel, for example a vehicle wheel. The lifting arms may be raised and lowered and locked in position to aid in removing and/or mounting vehicle wheels.

### TECHNICAL FIELD

Automotive equipment.

### BACKGROUND

Vehicle wheels are often heavy and cumbersome, which may make the handling of wheels, especially when mounting wheels on wheel hubs, a difficult task for one person to accomplish. Vehicle wheels may be removed and replaced for a variety of reasons such as, but not limited to, maintenance, repair, customization, etc. Even though an average person is typically capable of lifting a tire-mounted wheel of a passenger car off of the ground, one can expect that this may be a physically-demanding endeavor for some individuals when attempting to align the lug nut holes of the rim with the wheel studs on the wheel hub while lifting the wheel. A variety of devices have been proposed for lifting wheels to allow replacement, one of which is described in Canadian patent number 2124968. There is disclosed a new device for lifting wheels to assist in replacement them on vehicles.

### SUMMARY

In an embodiment there is disclosed a wheel lift, comprising a frame having ground engaging elements, the frame defining an open space for receiving a wheel, a four bar linkage structure supported by the frame, lifting arms extending from the four bar linkage, the lifting arms being spaced apart on either side of the open space for receiving and supporting a wheel, the lifting arms defining a forward side of the wheel lift, the four bar linkage structure having a handle for operating the four bar linkage to raise and lower the wheel, and the frame comprising a U-shaped structure defined by a base bar and a pair side bars extending from opposed sides of the base bar and a rearward extending bar extending from a mid-point of the base bar.

In various embodiments, there may be included any one or more of the following features: the four bar linkage structure comprises a first four bar linkage at a first side of the wheel lift and a second four bar linkage at a second side of the wheel lift and further comprising bars connecting the first four bar linkage to the second four bar linkage; the frame comprises frame members that lie in a plane and the first four bar linkage and the second four bar linkage each comprises upright members that extend perpendicularly to the plane; the handle is lockable in a fixed position relative to the frame; the handle is lockable in a fixed position relative to the frame by a lockable member connected between the handle and the rearward extending bar.

In a further embodiment there is provided a wheel lift, comprising a frame having ground engaging elements, the frame defining an open space for receiving a wheel and the frame being formed of frame members that lie in a first plane; a four bar linkage structure supported by the frame; lifting arms extending from the four bar linkage, the lifting arms being spaced apart on either side of the open space for receiving and supporting a wheel, the lifting arms defining a forward side of the wheel lift; the four bar linkage structure having a handle for operating the four bar linkage to raise and lower the wheel; the handle having a range of movement that includes a position in which the handle lies in a second plane parallel to the first plane; and in the normal operational position of the wheel lift with the ground engaging elements resting on a ground surface, the handle forms an upper boundary of the wheel lift.

In various embodiments, there may be included any one or more of the following features: the four bar linkage structure comprises a first four bar linkage at a first side of the wheel lift and a second four bar linkage at a second side of the wheel lift and further comprising bars connecting the first four bar linkage to the second four bar linkage; the first four bar linkage and the second four bar linkage each comprises upright members that extend perpendicularly to the first plane; in each four bar linkage one of the upright members is secured to the frame to be fixed relative to the frame during operation of the wheel lift; the frame comprises a U-shaped structure defined by a base bar and a pair side bars extending from opposed sides of the base bar and a rearward extending bar extending from a mid-point of the base bar.

In a further embodiment there is provided a wheel lift, comprising: a frame having ground engaging elements, the frame defining an open space for receiving a wheel; a four bar linkage structure supported by the frame; lifting arms extending from the four bar linkage, the lifting arms being spaced apart on either side of the open space for receiving and supporting a wheel, the lifting arms defining a forward side of the wheel lift; the four bar linkage structure having a handle for operating the four bar linkage to raise and lower the wheel; and the handle is lockable in a fixed position relative to the frame.

In various embodiments, there may be included any one or more of the following features: the frame comprises a U-shaped structure defined by a base bar and a pair side bars extending from opposed sides of the base bar and a rearward extending bar extending from a mid-point of the base bar; the handle is lockable in a fixed position relative to the frame by a lockable member connected between the handle and the rearward extending bar; the lockable member is telescoping; the handle is lockable in a fixed position relative to the frame by a lockable member that, in its inactivated mode, is in the fixed position; the lockable member is connected to be activated by a device on the handle; the device comprises a hand operated lever that when pulled by a hand places the lockable member in an open position in which the handle is free to rotate relative to the frame; in the normal operational position of the wheel lift with the ground engaging elements resting on a ground surface, the handle forms an upper boundary of the wheel lift.

A locking mechanism is also disclosed.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective view of an embodiment of a wheel lift.

FIG. 2 is a perspective view of the wheel lift of FIG. 1 showing the lifting arms in a raised position.

FIG. 3 is a top view of the wheel lift of FIG. 1.

FIG. 4 is a side view of the wheel lift of FIG. 1 showing the lifting arms in a lowered position.

FIG. 5 is a rear view of the wheel lift of FIG. 1.

FIG. 6 is a perspective view of an embodiment of the ground engaging element of the wheel lift of FIG. 1.

FIG. 7 is a perspective view of a further embodiment of the ground engaging element of the wheel lift of FIG. 1.

FIG. 8 is a perspective view of a further embodiment of the ground engaging element of the wheel lift of FIG. 1.

### DETAILED DESCRIPTION

Immaterial modifications may be made to the embodiments described here without departing from what is covered by the claims.

An embodiment of the present invention may provide a wheel lift. This embodiment may be used mainly for mounting wheels yet may also be used for removing wheels and may act as a counter weight. Some embodiments provide an efficient mechanism for a user to mount a wheel on a vehicle's wheel hub comprising means of adjusting the position and orientation of the wheels such that the wheel can be smoothly slid onto the wheel hub of a vehicle. In some embodiments this mechanism may allow multiple degrees of freedom in the motion of the wheel including, without limitation, vertical height, arbitrary motion along the plane of the ground, and clockwise or counterclockwise rotation along the axis of the wheel. In this manner, a wheel can be adjusted to the proper position and its lug nut holes aligned with the studs on the wheel hub such that the wheel can be easily slid into position on the wheel hub.

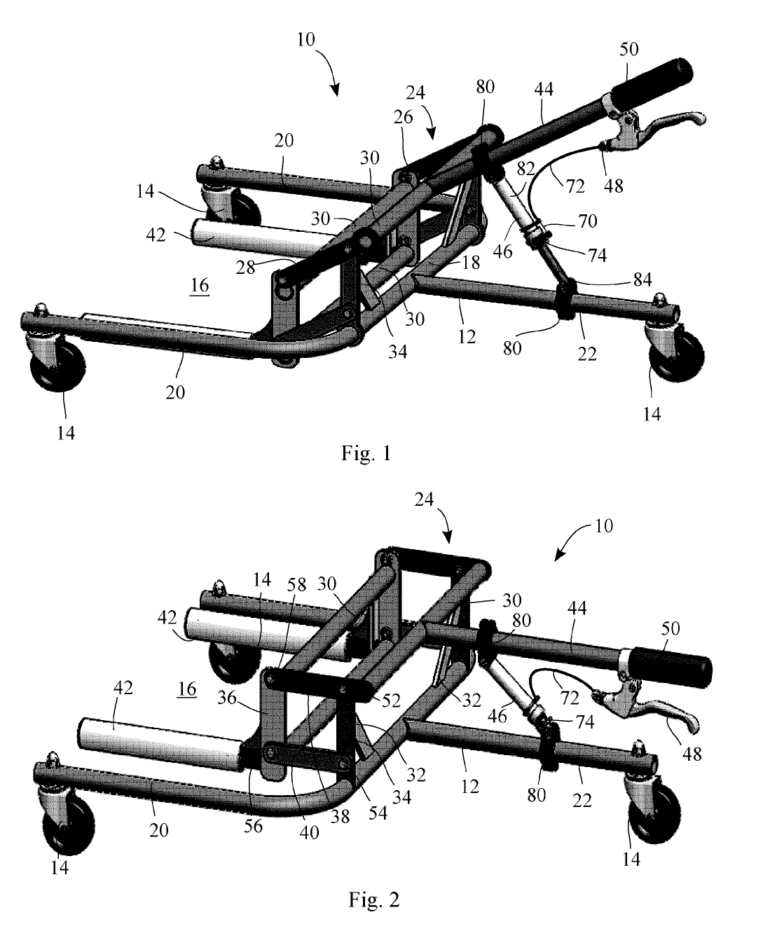

FIG. 1 shows an exemplary wheel lift 10 having a frame 12 having ground engaging elements 14. The frame 12 defines an open space 16 for receiving a wheel, for example, a vehicle wheel. The frame 12 may be a U-shaped structure defined by a base bar 18 and a pair of side bars 20 extending from opposed sides of the base bar 18 and a rearward extending bar 22 extending from a mid-point of the base bar 18. The frame in some alternate embodiments may be implemented in various different shapes and sizes. For example, in some embodiments the bars may he bent or curved rather than straight or angled throughout. In some embodiments, the rearward extending bar may be formed of several bars, which, depending on the embodiment, may not be centrally located.

The wheel lift 10 has a four bar linkage structure 24 supported by the frame. The four bar linkage structure 24 may comprise a first four bar linkage 26 at a first side of the wheel lift and a second four bar linkage 28 at a second side of the wheel lift. There may be bars 30 connecting the first four bar linkage to the second four bar linkage. The four bar linkage structure may comprise a single four bar linkage positioned at a midpoint on the bar.

Referring to FIG. 2, the first four bar linkage and the second four bar linkage each may comprise upright members 34, 36 that extend perpendicularly to a first plane in which the frame members lie. The plane of the frame may be parallel to the plane of the ground. In each four bar linkage one of the upright members 34 may be secured to the frame to be fixed relative to the frame during operation of the wheel lift. The first and second four bar linkages each comprise members 34, 36, 38, 40 that that are arranged to have an operational range of movement that includes a position in which the members 38 and 40 are parallel to the plane of the frame, as shown in FIG. 2. Members 38 and 40 are pivotally connected to secured upright member 34 at fixed pivots 52 and 54 respectively. Members 36 and 40 are pivotally connected to each other at pivot 56 and members 36 and 38 are pivotally connected to each other at pivot 58.

Support bars 32 may stabilize the first and second four bar linkages 26, 28 against the frame 12. The support bars 32 may extend from base bar 18 to upright members 34. Members 34, 36, 38 and 40 may be plates extending from the first side of the wheel life to the second side of the wheel lift, instead of bars.

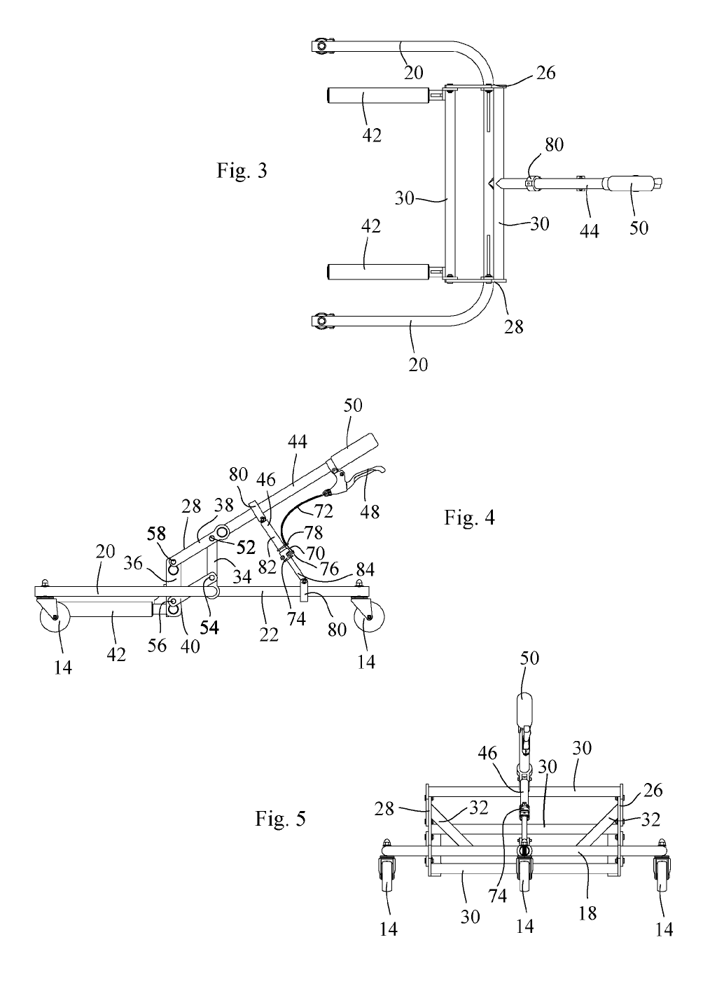

Referring to FIG. 3, there are lifting arms 42 extending from the four bar linkage 24. The lifting arms 42 are spaced apart on either side of the open space 16 for receiving and supporting a wheel. The lifting arms may be mounted forward of the four bar linkage. The lifting arms may define a forward side of the wheel lift.

The lifting arms may have rollers mounted on the lifting arms 42 to allow the user to adjust the position of a wheel resting on the lifting arms. The wheel rests on the rollers and can be rotated to the proper position and its lug nut holes aligned with the stubs on the wheel hub. The rollers may be cylindrical bars rotatably mounted to each lifting arm 42. The rollers may have a smooth or rough outer surface to provide better grip on the tire.

Referring to FIG. 4, the four bar linkage 24 has a handle 44 for operating the four bar linkage to raise and lower the wheel. To operate the wheel lift, the handle is moved in an operational range of movement that includes a raised position and a lowered position. The lowered position may be a position in which the handle lies in a second plane parallel to the first plane. In a normal operational position of the wheel lift with the ground engaging elements 14 resting on a ground surface, the handle 44 forms an upper boundary of the wheel lift 10 such that no frame elements are above the handle. The handle 44 forms the upper boundary of the wheel lift throughout the entire range of motion of the handle. The disclosed wheel lift may have the advantage of being portable in some embodiments, and the limited height of the wheel lift achieved for example by the handle forming an upper part of the wheel lift helps make the wheel lift portable.

The handle may form a lever with a fulcrum at joint 52. The lengths of the members of the four bar linkage may be extended or shortened between the pivots or beyond the pivots to change leverage ratio to, for example, lighten the effort required while adjusting the height of the wheel.

In operation of the wheel lift a wheel is supported by the lifting arms 42. The user may lower the handle 44 from a raised position (as shown in FIG. 4), causing the lifting arms 42 to be raised. When the handle 44 is in a lowered position, as in FIG. 2, the lifting arms 42 are in a raised position. The four bar linkage members 38 and 40 may be in a position parallel to the plane of the frame 12 when the lifting arms 42 are in the raised position. In the lowered position the handle 44 may be parallel to the rearward extending bar 22, or the handle 44 may be at an angle to the rearward extending bar 22. Conversely, to lower the lifting arms 42 the handle 44 may be raised. In some embodiments the handle 44 and the four bar linkage members 34, 36, 38, 40 may be implemented in various different shapes and sizes. For example, the handle 44 and the four bar linkage members 34, 36, 38, 40 may be bent or curved rather than straight or angled throughout. The handle 44 may be parallel to member 38 or the handle may be angled with respect to member 38. The handle 44 may include a handle grip 50 at the rearward end of the handle 44.

The lifting arms may be mounted at a fixed angle to four bar linkage member 36, so that as the lifting arms are raised or lowered throughout an operation range of movement the lifting arms remain parallel to the plane of the frame.

The handle 44 may be lockable in a fixed position relative to the frame by a lockable member 46. In its inactivated mode, the lockable member may be in the fixed position. When the lockable member 46 is locked the lifting arms 42 are also fixed in position. The lockable member 46 has a cylinder 82, a rod 84 and a lock 74 at the lower end of the cylinder 82. The lockable member may be telescoping where the cylinder 82 telescopically receives the rod 84 and thus have variable length. Lock 74 has clamp lock plates 76 that extend around the rod 84. When the lockable member 46 is in the fixed position clamp lock plates 76 so that they are angled with respect to the rod 84 so that they grip the rod. The lockable member may have a spring that holds the lock 74 in a fixed position. The lockable member 46 is connected to be activated by a device 48 on the handle. The device 48 may be a hand operated lever or other cable moving part that may move a cable, though in some embodiments other devices may be used, such as a button that is pushed or a handle that is rotated, with a suitable connecting element between the device and the lockable member. In various embodiments, other designs may be used for the lockable member 46 such as a linear actuator. In other embodiments, the locking mechanism may be used in other applications that require fixing of one member (for example the handle 44) and another member (for example the rearward extending bar 22).

In the embodiment shown, a cable 70 extends from the device 48 to the clamp lock plates 76. When the user pulls on the brake lever 48 the lockable member is placed in an open position in which the handle 44 is free to rotate relative to the frame. When the lockable member is in the open position, the cable 70 pulls the clamp lock plates 76 so that they are straightened with respect to the rod 84 and allow the rod to move. Cable sheath 72 is a tube which is able to hold the cable 70 in a static position and extends from the brake lever 48 to the clamp plate 78. The lockable member 46 may be secured to the handle 44 and to the rearward extending bar 22 by clamps 80. In some embodiments, the lockable member may extend between the handle and another part of the frame, for example the base bar or another element extending from the base bar.

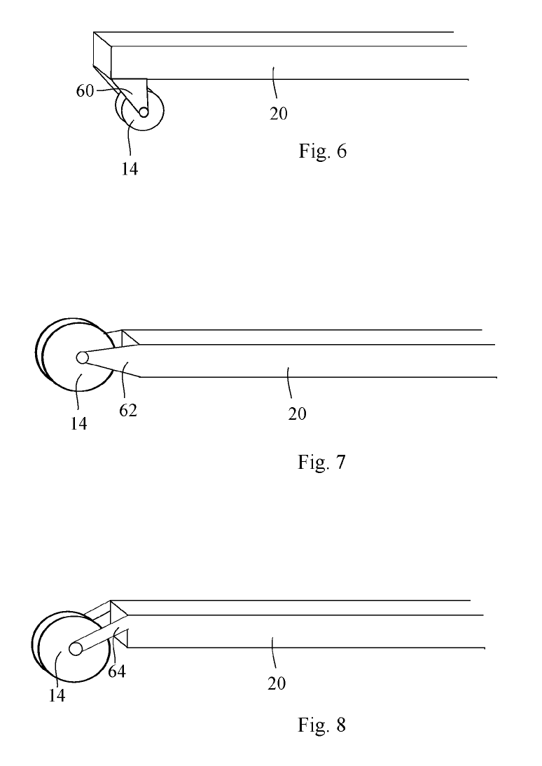

Referring to FIGS. 6-8, the ground engaging elements 14 may be wheels allowing the frame to be mobile. The ground engaging elements 14 may be attached to the side bars 20 and to the rearward facing bar 22 of the frame 12. The ground engaging elements 14 may be pivotally attached to the side bars 20 and to the rearward facing bar 22 by attachment 60 as shown in FIG. 6. In some embodiments, the ground engaging elements 14 may be attached to the side bars 20 and to the rearward facing bar 22 by attachment 62 as shown in FIG. 7, or by attachment 64, as shown in FIG. 8.

Some embodiments may implement the use of retractable frames so that the size of the apparatus can be changed at the user's discretion. Changing the size of the apparatus may enable the user to achieve various different actions including accommodating of more wheel sizes, making the apparatus more compact for storage in tight spaces and increasing the leverage ratio so as to reduce the effort required while performing height adjustment. Retractable frames can easily be achieved by using hollow tubes of different sizes such that the tubes with smaller diameters can slide into the tubes with larger diameters.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1-16. (canceled)

17. A wheel lift, comprising:
a frame having ground engaging elements, the frame defining an open space for receiving a wheel, the frame comprising a U-shaped structure defined by a base bar and a pair of side bars extending from opposed sides of the base bar and a rearward extending bar extending from a mid-point of the base bar, at least one of the ground engaging elements supporting the rearward extending bar;
a four bar linkage structure supported by the frame, in which the four bar linkage structure comprises a first four bar linkage at a first side of the wheel lift and a second four bar linkage at a second side of the wheel lift and further comprising bars connecting the first four bar linkage to the second four bar linkage;
the base bar and the pair of side bars lie in a first plane and the first four bar linkage and the second four bar linkage each comprises upright members that extend perpendicularly to the plane;
in each of the first four bar linkage and the second four bar linkage one of the upright members is secured to the U-shaped frame to be fixed relative to the frame during operation of the wheel lift
lifting arms extending from the four bar linkage, the lifting arms being spaced apart on either side of the open space for receiving and supporting a wheel, the lifting arms defining a forward side of the wheel lift
the four bar linkage structure having a handle that extends rearwardly for operating the four bar linkage structure to raise and lower the wheel;
the handle being lockable in a fixed position relative to the frame by a lockable member connected between the handle and the rearward extending bar, the lockable member being telescoping, the lockable member, the handle and the rearward extending bar being aligned in a second plane that is perpendicular to the first plane;
the lockable member being connected to be activated by a hand operated lever on the handle that when pulled by a hand places the lockable member in an open position in which the handle is free to rotate relative to the frame;
the handle having a range of movement that includes a position in which the handle lies in a third plane parallel to the first plane; and
in the normal operational position of the wheel lift with the ground engaging elements resting on a ground surface, the handle forming an upper boundary of the wheel lift.

18-20. (canceled)
